(19) United States
(12) Patent Application Publication
(10) Pub. No.: US 2010/0091187 A1
(43) Pub. Date: Apr. 15, 2010

(54) METHOD AND AUDIO/VIDEO DEVICE FOR PROCESSING CAPTION INFORMATION

(75) Inventor: Sanjiv Topiwalla, (US)

Correspondence Address: SETTER ROCHE LLP, PO BOX 780, ERIE, CO, 80516, US

(73) Assignee: EchoStar Technologies L.L.C., Englewood, CO (US)

(21) Appl. No.: 12/252,146

(22) Filed: Oct. 15, 2008

(51) Int. Cl. H04N 7/01

(52) U.S. Cl. 348/468; 348/E07.003

(57) ABSTRACT

A method for operating an audio/video device is presented, comprising receiving first caption data into the audio/video device, receiving second caption data into the audio/video device, processing the first caption data to display caption information in a first format, after the processing of the first caption data, receiving an instruction to display caption information in a second format, and in response to the instruction, processing the second caption data to display the caption information in the second format.

### BACKGROUND

Many audio/video programs, including movies, sporting events, newscasts, and the like, provide captioning (often referred to as “closed captioning”) information. Many types of devices that provide such audio/video programming to a user, including televisions, digital video disc (DVD) players, and set-top boxes, are often required by way of government regulation to offer this captioning information in conjunction with the video portion of the programming at the option of the user. For example, if the user configures the device (typically by way of a menu system provided by the device) to display closed captioning information, the device presents the video portion of the program along with the captioning on a display, such as a television or monitor screen. Typically, the captioning is a textual representation of the dialogue and other elements of the audio data accompanying the video portion of the program, and its presentation is generally synchronized with the program audio data.

Several different formats for displaying closed captioning information are employed in modern programming. Initially, the Electronic Industries Alliance (EIA) 608 format was developed. This format results in a familiar display of black blocks with white text within the blocks. Relatively few options are available to the user for displaying EIA-608 captions. Most, if not all, standard definition television sets are capable of displaying EIA-608 captioning. Recently, the EIA-708 standard has been developed and employed for caption display in high definition environments. EIA-708 captioning provides the user with a wide variety of viewing options, such as font, background, and color selection, among other options.

Most audio/video programming is transmitted with caption information in both the EIA-608 and EIA-708 format. Caption data carrying the EIA-608 formatted caption information is transmitted along with caption data carrying the EIA-708 formatted caption information. The caption data is usually embedded within a signal carrying the video and audio data for the audio/video program.

The default mode for many High Definition capable audio/video devices is to display EIA-708 formatted caption information when available. At times, the EIA-708 information may not be available. In these cases, many audio/video devices automatically default to the EIA-608 information. However, in other cases, the EIA-708 may be available, but when displayed is rendered in an unintelligible manner. This could occur if the caption data or EIA-708 caption information itself is corrupted. Unfortunately, users are left with no choice but to disable the closed captioning altogether, or view the unintelligible display.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a block diagram of an entertainment system including an audio/video device according to an embodiment of the invention.

FIG. 2 is a flow diagram of a method according to an embodiment of the invention for operating the audio/video device of FIG. 1.

FIG. 3 is a block diagram of an audio/video device according to an embodiment of the invention.

FIG. 4 is a graphical representation of the display of the output device of FIG. 3 with caption information in a high definition format.

FIG. 5 is a graphical representation of the display of the output device of FIG. 3 with corrupted caption information.

FIG. 6 is a graphical representation of the display of the output device of FIG. 3 with menu selections enabling a user to change caption formats.

FIG. 7 is a graphical representation of the display of the output device of FIG. 3 with caption information in a standard definition format.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

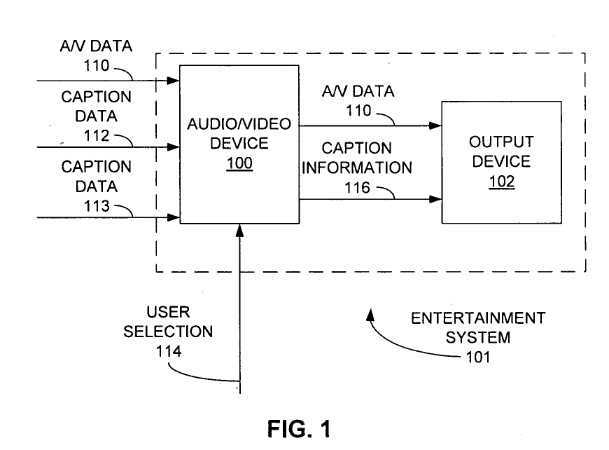

FIG. 1 is a simplified depiction of an entertainment system 101 including an audio/video device 100 according to an embodiment of the invention. Examples of the audio/video device 100 include, but are not limited to, television sets or monitors; television set-top boxes for satellite, cable, and terrestrial broadcast systems; digital video disc (DVD) players; digital video recorders (DVRs); and computer systems, as well as any other device capable of presenting audio/video programming for display to a user. The audio/video device 100 is coupled with an output device 102, such as a television or monitor. While the output device 102 is displayed as being physically separate from the audio/video device 100, the two components 100, 102 may be integrated as a single system, such as in a television or laptop computer.

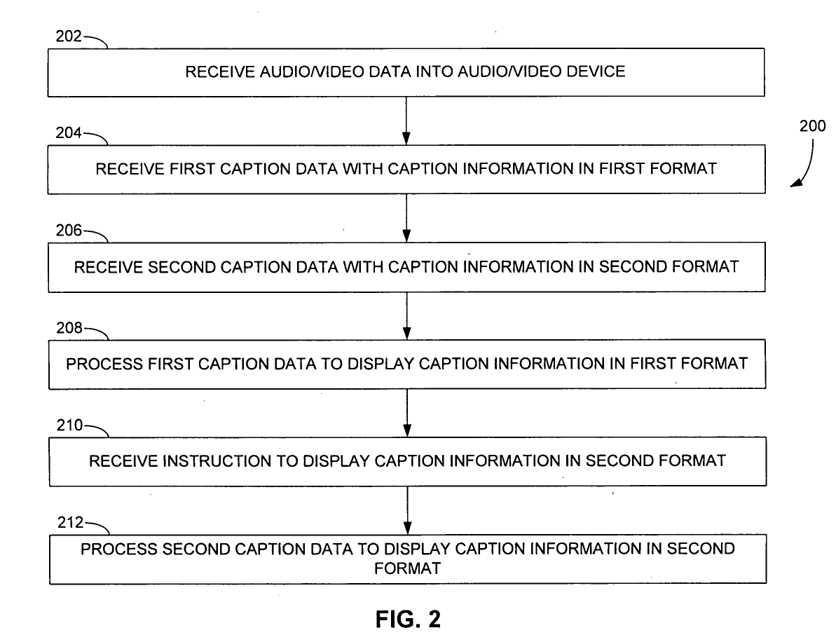

FIG. 2 provides a flow diagram of a method 200 for operating the audio/video device 100 of FIG. 1. However, the method 200 may be employed on other similar devices not specifically described herein.

In the method 200, audio/video data 110 is received into audio/video device 100 (operation 202). Caption data 112 carrying caption information associated with the audio/video data 110 is also received into the audio/video device 100 (operation 204). The caption information embedded within caption data 112 may be in a first format. In addition, caption data 113 also carrying caption information associated with the audio/video data 110 is received into the audio/video device 100 (operation 206). The caption information carried by caption data 113 may be in another format different than the format of the caption information carried by caption data 112. Along with the audio/video data 110, caption data 112 is processed to display the caption information carried by caption data 112 (operation 208). The caption information is displayed according to the first format. In one implementation, the audio/video data 110 may be reformatted or otherwise altered by the audio/video device 100 before presentation for display.

At times, it may be desirable to change the format of the caption information. As illustrated in FIG. 2, an instruction is received to display the caption information in a different format (operation 210). In response to the instruction, caption data 113 is processed to display the caption information in a second format (operation 212). While FIG. 2 indicates a specific order of execution of the operations 202-212, other possible orders of execution, including concurrent execution of one or more operations 202-212, may be undertaken in other implementations. In another embodiment, a computer-readable storage medium may have encoded thereon instructions for a processor to direct the audio/video device 100 to implement the method 200.

Thus, use of one or more of the embodiments described herein may facilitate viewing of caption information in one format, followed by viewing the caption information in another, different format. This could benefit a viewer in circumstances where the caption information carried by caption data 112 is corrupted. Likewise, this could assist test personnel with diagnosing system operations.

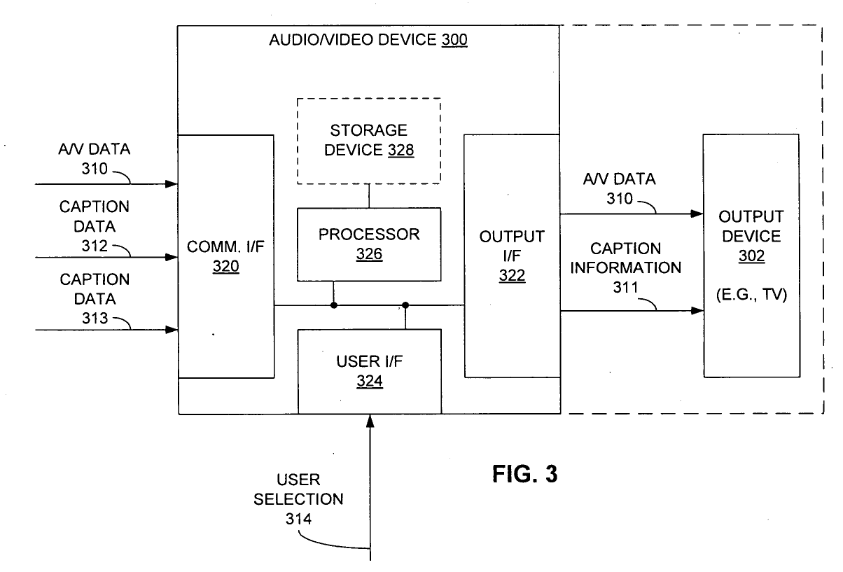

FIG. 3 provides a block diagram of an audio/video device 300 according to another embodiment of the invention. The audio/video device 300 includes at least a communication interface 320, an output interface 322, a user interface 324, and a processor 326. Optionally, the audio/video device 300 may include a storage device 328, described in greater detail below.

As with the audio/video device 100 of FIG. 1, examples of the audio/video device 300 of FIG. 3 include, but are not limited to, satellite, cable and terrestrial television set-top boxes; television sets, monitors, and video displays; digital video disc (DVD) players; digital video recorders (DVRs); and computers. As a result, circuitry normally associated with such devices may be present in the audio/video device 300, but is not explicitly illustrated in FIG. 3. For example, in the case of a satellite set-top box, the audio/video device 300 may include one or more tuners, as well as descrambling and decoding circuitry, in the communication interface 320. The audio/video device 300 may also incorporate DVR functionality, as well as other circuitry typically incorporated into satellite set-top boxes, that is not shown in FIG. 3. Such detail is not described or depicted in FIG. 3 to simplify and facilitate the following discussion.

The audio/video device 300 is coupled with an output device 302, such as a television set, monitor, or the other video display. While the output device 302 is displayed as being physically separate from the audio/video device 300, the two devices 300, 302 may be integrated as a single system, such as in a television set or laptop computer system.

The communication interface 320 of the audio/video device 300 is configured to receive audio/video data 310, as well as caption data 312 and caption data 312. Caption data 312 and caption data 313 each carry caption information associated with the audio/video data 310. The communication interface 320 may take any number of forms depending on the type of audio/video device 300. For example, if the audio/video device 300 is a satellite set-top box, the communication interface 320 may include circuitry for receiving a satellite signal from an antenna, down-converting the signal, selecting a particular transponder frequency, descrambling and/or decoding the data packets of the signal, selecting those data packets associated with a particular programming channel, and so on. Thus, the satellite signal may include audio/video data 310, caption data 312, and caption data 313 embedded therein.

If, instead, the audio/video data 300 is a DVD player, the communication interface 320 may be a laser diode and related servo circuitry, along with read synchronization and decoding circuitry, to enable the audio/video device 300 to read the audio/video data 310 and associated caption data 312 and caption data 313 from a DVD. As a result, the communication interface 320 may receive the audio/video data 310, caption data 312, and caption data 313 from any of a number of sources, including, but not limited to, a satellite, a cable, a terrestrial source, a digital storage medium, and a computer network or other communication network.

In one implementation, the audio/video data 310 may incorporate one of the Motion Picture Experts Group (MPEG) standards for data encoding and compression, such as MPEG-2 or MPEG-4. Other data formatting or encoding methods, both analog and digital, may be employed in other embodiments.

In one example, the caption data 312 of FIG. 3 may conform to the closed captioning standards developed by the Electronics Industry Alliance (EIA), such as the EIA-708 standard for ATSC (Advanced Television Systems Committee) high-definition television broadcasts in both the United States and Canada. Likewise, the caption data 313 of FIG. 3 may conform to the EIA-608 standard for NTSC (National Television System Committee) standard-definition television broadcasts. Other captioning formats, including those implemented according to standards supported by countries other than the United States and Canada, may be utilized for the caption data 312 or caption data 313 in other embodiments.

The output interface 322 of the audio/video device 300 is configured to transmit at least the audio/video data 310 received by the communication interface 320 to the output device 302. Typically, the output interface 322 is configured to reformat the received audio/video data 310 so that the audio/video data 310 may be processed by the output device 302 for presentation to a user. For example, the audio/video data 310 may take the form of audio and video data suitable for transport over one or more of several audio/video connections, including, but not limited to, coaxial cable, composite video with separate audio channels, component video with separate audio channels, and the High-Definition Multimedia Interface (HDMI).

Initially, the output interface 322 is also configured to transmit at least the caption information carried by caption data 312 to the output device 302. The caption information is then displayed by the output device 302 in a first format, such as EIA-708.

The user interface 324 depicted in FIG. 3 is configured to receive a selection from a user indicating a desire to alter which caption information is displayed. In one example, the user interface 324 may be implemented as a user panel located on the audio/video device 300; a remote control interface adapted to receive commands electrically, optically, acoustically, or by other means from a remote control device (not shown in FIG. 3); or by any other form of user control over the audio/video device 300.

Within the audio/video device 300, communicatively coupled with each of the communication interface 320, the output interface 322, and the user interface 324, is a processor 326. In one embodiment, the processor 326 may be one or more microprocessors, microcontrollers, digital signal processors (DSPs), or any other processor configured to execute software instructions for performing the various tasks identified with the processor 326, such as coordinating the activities of the other components of the audio/video device 300, as well as the specific operations discussed in greater detail below. The software may be stored in a data storage device, such as the storage device 328 shown in FIG. 3, or a memory located internal to the processor 326. In another example, the processor 326 may be a collection of hardware logic circuitry to perform the functions described below, or a combination of software and hardware elements.

The storage device 328, if included in the audio/video device 300, may incorporate one or more types of data storage, such as static random access memory (SRAM), dynamic random access memory (DRAM), flash memory, or other integrated circuit (IC) based memory; optical or magnetic disk memory; or any other type of storage device or system capable of storing data. In another embodiment, the storage device 328 may include network-attached storage to which the audio/video device 300 may be coupled through the communication interface 320 or other suitable connection.

Through the user interface 324, a user may also configure the audio/video device 300 to transmit either the caption information carried by caption data 312 or the caption information carried by caption data 313 to the output device 302 for presentation to the user. Typically, the caption information is displayed as alphanumeric text, and possibly special-purpose characters, in a graphics box displayed over a portion of the video being presented to the user on the output device 302. Whether the caption information is displayed on the output device 302 is typically determined by the user via a menu selection or other means provided by the audio/video device 300 through the user interface 324. The choice to display the caption information is often made by individuals possessing hearing impairments, as well as those viewers for whom the language of the viewed program may be difficult to understand, especially at the rate of normal conversation.

When available, users typically select high definition captioning as their viewing preference. Towards this end, caption data 312 carrying caption information in a high definition format is processed for display on output device 302. However, it may occur that the caption information is corrupted. For example, corruption of the caption information may occur at the early encoding stage of the caption information. In another example, the caption information may become corrupted due to a malfunctioning decoder process. Regardless, corrupted caption information may be rendered by output device 302 in an unintelligible form for the viewer.

In response to perceiving unintelligible caption information, the user of the audio/video device 300 may indicate via a user selection 314 to change the caption information. Any of several methods may be employed to allow the user to change the format of the caption information by way of the user interface 324 operating in conjunction with the processor 326. For example, the user may select from a graphical menu displayed on output device 302. In another example, the user may select a physical button on a peripheral device, or on audio/video device 300, itself.

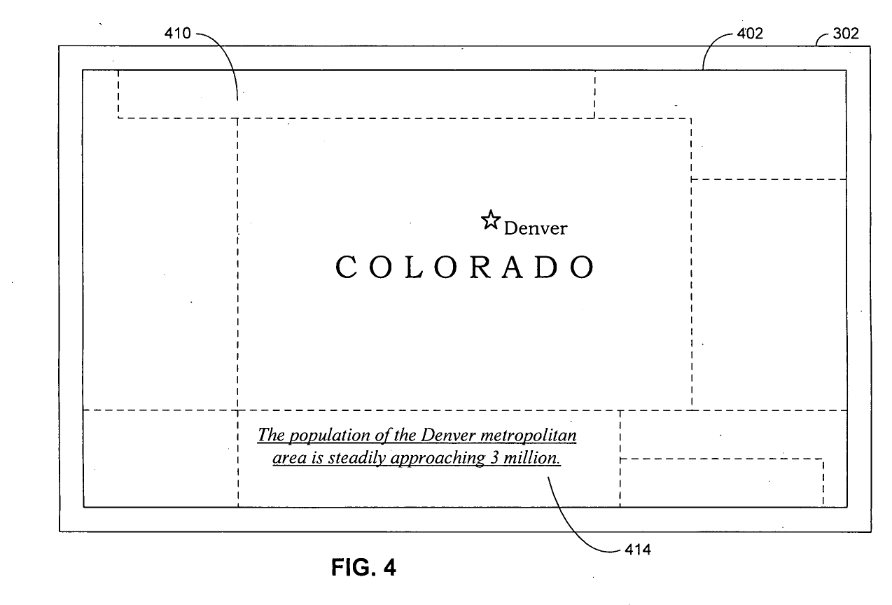

FIGS. 4-7 provide an operation example of a user selecting and changing caption information formats. In response to the user selection, processor 326 processes caption data 313 to display the caption information carried by caption data 313 in a standard definition format. Processor 326 transfers the caption information in the standard definition format to output interface 322. Output interface 322 transfers the audio/video data 310 and the caption information 311 to output device 302 for display to the user. The caption information is thus initially displayed in a high definition format, and is then displayed in a standard definition format. This allows the user to view the caption information in another format which may be more intelligible, rather than viewing corrupted caption information

FIG. 4 provides an example of the output device 302 with a video display 402, upon which video data 410 of a program is being displayed. Presented with the video data 410 is caption information 414 associated with the video data 410. In this particular example, the caption information is formatted in a high definition format. In FIG. 4, the caption information is displayed properly, in an intelligible manner for viewing by the user. For example, the text is in italics, underlined, and of a particular font, and with no obtrusive background that would otherwise obstruct the underlying image.

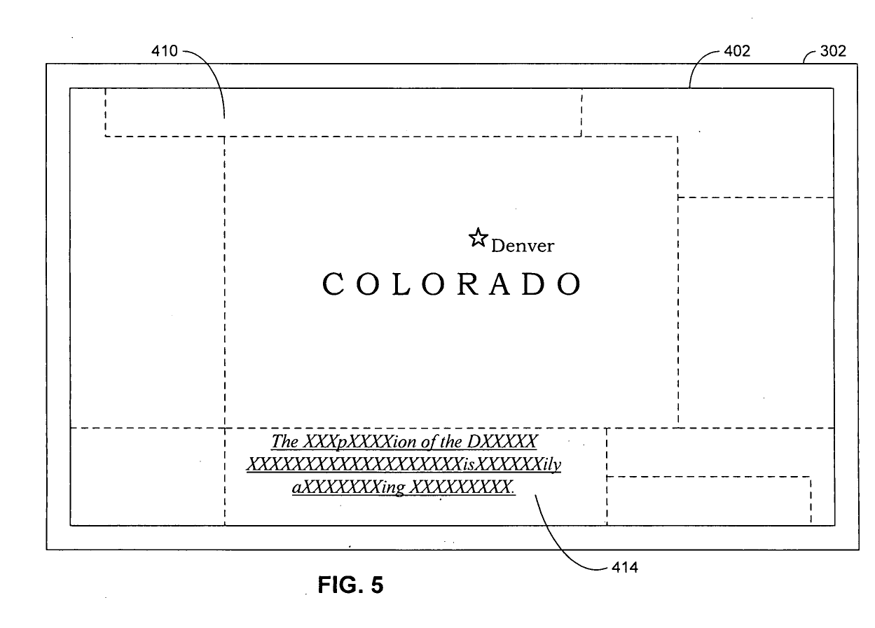

Referring to FIG. 5, the same video data 410 of a program is displayed. However, in this example the caption information is corrupted. As is shown, many characters are scrambled, resulting in an unintelligible group of characters. Such corrupted text may occur for a variety of reasons, such as a faulting encoding process, or faulty decoding process, or otherwise.

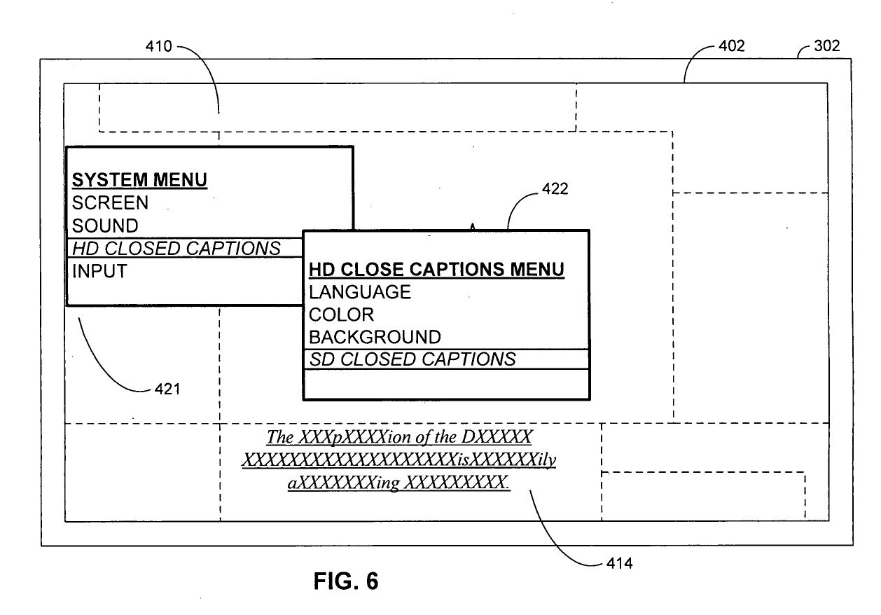

FIG. 6 illustrates a user driven graphical menu that may allow a user to change the captioning format displayed on output device 302. As can be seen from FIG. 6, the caption information 414 is displayed in a corrupted form. A user, operating a remote control activates a system menu 421. System 421 is shown has having several menu options, namely: screen, sound, high definition (HD) closed caption options, and input. It should be understood that system menu 421 is merely representative of a user controlled menu. Many other options and configurations are possible.

Operating a remote control, the user can select any of the options presented in the system menu 421. For example, the user could selection “screen”, “sound”, or “input” to modify aspects of output device 302. Likewise, the user could select “HD closed captions” to modify aspects of the high definition closed captioning illustrated by caption information 414.

Upon selecting HD closed captions, an HD closed captions menu 422 is displayed. Several options are available within the HD closed captions menu. For example, the user could modify the language in which caption information is displayed, the color of the closed caption text, or background features of the closed captioning. It should be understood that the various user defined options available within high definition closed captioning schemes, such as EIA-708, are well known.

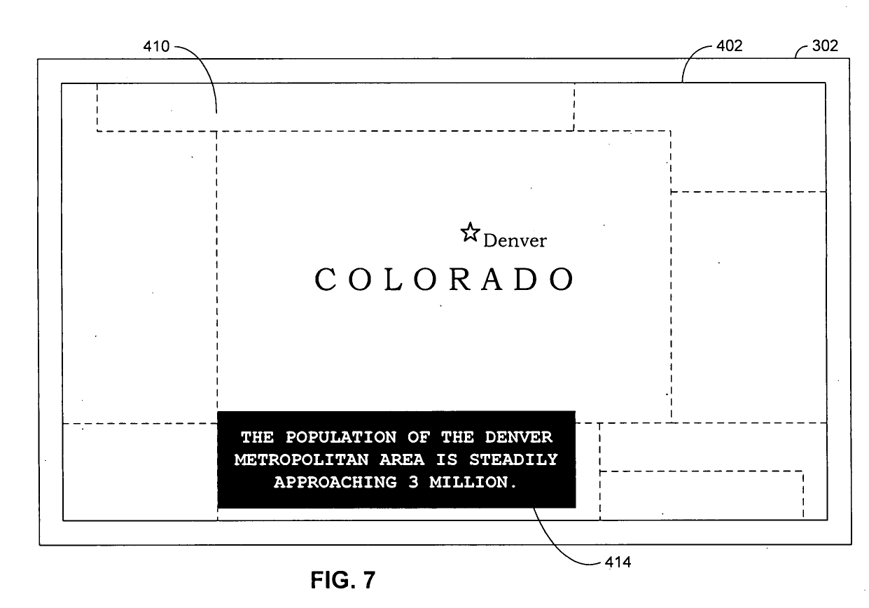

As shown in FIG. 6, an additional menu option is displayed: “SD closed captions.” This menu option, when selected, changes the closed captioning scheme from a high definition scheme to a standard definition scheme. In particular, user interface 324 receives a user selection indicating a selection of the SD closed captions option of HD closed captions menu 422. User interface 324 transfers an instruction to processor 326 to process caption data 313, rather than caption data 312, to display the caption information in a standard definition format. In response, processor 326 receives caption data 313 from communication interface 320, processes the caption data, and transfers caption information in a standard definition format to output interface 322, such as EIA-608. Output interface 322 transfers the caption information in the standard definition format to output device 302. Output device 302 displays the caption information in a standard definition format, as shown in FIG. 7.

Referring to FIG. 7, the characteristics of the caption information in a standard definition format are of a lower quality than the characteristics of the caption information in a high definition format. For example, the caption information 414 in FIG. 7 is displayed in a basic font, and in all capital letters, rather than a stylistic font and a variety of capitalization and lower case letters. In addition, an area surrounding the text is filled in with a solid color, thereby obstructing a portion of the underlying images intended for video display 402. The relative differences between high definition and low definition captioning will be familiar to those skilled in the art.

In this manner, a user is allowed to alter the format of the caption information displayed by output device 302. In the event of corrupted caption information in a high definition data stream, the user can control audio/video device 300 to utilize standard definition caption information instead. This capability may also be useful for diagnostic purposes. For example, it may be useful to test the operation of audio/video device 300 by displaying caption information first in a high definition format, and then in a standard definition format.

In a direct broadcast satellite example, a set-top box (STB) receives closed captioning data with a program, and generates the on-screen text and graphics for the captions before passing the resulting video signal to the TV. The STB receives two types of closed captioning: EIA-608 captions, and EIA-708 captions. EIA-608 captions (also know as “line 21” captions, used on NTSC and standard def (SD) digital channels), allows for few languages options, and few font, color, and screen position possibilities. Little or no modification is allowed by the user.

In contrast, EIA-708 captions (used on high def (HD) channels), allow for up to 32 different “services” (e.g., languages) numbered 1-32. It should be understood that typically much less than 32 options are actually provided. Normally, 1-7 services are supported. In addition, many font, color, and screen position options are available. Indeed, many more user-specified preferences for display are possible via EIA 708 relative to EIA 608.

In transmission of a satellite signal, captioning information (i.e. the text associated with audio portions of an audio/video feed) is transmitted twice: once in the EIA-708 format and again within the EIA-608 format. The caption information is carried within data packets received with the other programming. In fact, EIA-708 captioning data is required for ATSC compatibility.

In both cases, the captioning data carrying the caption information is received in packets as MPEG-2 user data. The data rate of EIA-708 data is 9600 bps, whereas the data rate for EIA-608 data is 960 bps.

Not all HD channels provide EIA-708 data with programming. For example, a specific program being shown may not have any EIA-708 data associated with it. In that case, the STB automatically shows the EIA-608 data. When EIA-708 data is available, many STBs show just the EIA-708 data; the EIA-608 data is ignored.

Very often, the EIA-708 data received from the supplier is corrupted or garbled. This may occur due to a cheap or ineffective EIA-708 encoder at the supplier end, as opposed to a bad EIA-708 decoder in the STB, or noise in the transmission of the overarching satellite signal. Nevertheless, the STB always shows only the EIA-708 data (when present), even if EIA-608 data is available.

Rather than display corrupted EIA-708 data, in this example, a user may select the EIA-608 data in the presence of EIA-708 data. In particular, a service option indicated by a service ‘0’ is added to the STB user service selection options menu, in addition to options 1-32. This allows the user to select the EIA-608 data for display, even if the EIA-708 data is available. As a benefit, a user can access EIA-608 captions if the EIA-708 data is corrupted. This also allows engineers to check the functionality of closed captioning receiver and decoder circuitry. For instance, if EIA-608 data is being received and decoded correctly, a problem with the EIA-708 data is likely not caused by the transmission or decoding of the data.

As can be understood from the embodiments above, the selection of one format over the other is allowed to the end user via an interactive menu option, which further allows the various user font style, color, etc, preferences to be applied to both the caption formats.

While several embodiments of the invention have been discussed herein, other embodiments encompassed by the scope of the invention are possible. For example, while various embodiments have been described primarily within the context of satellite set-top boxes, any other device that provides captioning data, such as cable and terrestrial set-top boxes, television sets and monitors, DVD players, and various computer systems, may benefit from application of the various concepts described herein. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method of operating an audio/video device, the method comprising:
receiving first caption data into the audio/video device;
receiving second caption data into the audio/video device;
processing the first caption data to display caption information in a first format;
after the processing of the first caption data, receiving an instruction to display the caption information in a second format; and
in response to the instruction, processing the second caption data to display the caption information in the second format.

2. The method of claim 1 wherein the caption information comprises textual data corresponding to audio in audio/video data.

3. The method of claim 1 further comprises displaying the caption information in the first format.

4. The method of claim 3 further comprising displaying the caption information in the second format.

5. The method of claim 4 wherein receiving the instruction comprises receiving a user selection indicating a desire to view the caption information in the second format, wherein the caption information in the first format is corrupted, and wherein the caption information in the second format is not corrupted.

6. The method of claim 4 wherein the first format comprises a high definition (HD) captioning format and wherein the second format comprises a standard definition (SD) captioning format.

7. The method of claim 6 wherein the SD captioning format comprises Electronic Industries Alliance (EIA) 608 and wherein the HD captioning format comprises EIA-708.

8. A computer-readable medium having encoded thereon instructions for a processor of an audio/video device to direct the audio/video device to perform a method comprising:
receiving first caption data into the audio/video device;
receiving second caption data into the audio/video device;
processing the first caption data to display caption information in a first format;
while displaying the caption information in the first format, receiving an instruction to display the caption information in a second format; and
in response to the instruction, processing the second caption data to display the caption information in the second format.

9. An audio/video device, comprising:
a communication interface configured to receive first caption data and receive second caption data;
a processor configured to process the first caption data to display caption information in the first format; and
a user interface configured to receive an instruction to display the caption information in a second format;
wherein the processor is further configured to, in response to the instruction, process the second caption data to display the caption information in the second format.

10. The audio/video device of claim 9 wherein the caption information comprises textual data corresponding to audio in audio/video data.

11. The audio/video device of claim 9 further comprising an output device configured to display the caption information in the first format.

12. The audio/video device of claim 11 wherein the output device is further configured to display the caption information in the second format.

13. The audio/video device of claim 12 wherein the user interface is configured to receive a user selection indicating a desire to view the caption information in the second format, wherein the caption information in the first format is corrupted, and wherein the caption information in the second format is not corrupted.

14. The audio/video device of claim 12 wherein the first format comprises a high definition (HD) captioning format and wherein the second format comprises a standard definition (SD) captioning format.

15. The audio/video device of claim 14 wherein the SD captioning format comprises Electronic Industries Alliance (EIA) 608 and wherein the HD captioning formation comprises EIA-708.

16. The audio/video device of claim 9, wherein the communication interface is configured to receive the first caption data and the second caption data from a satellite.

17. The audio/video device of claim 9, wherein the communication interface is configured to receive the first caption data and the second caption data from a cable.

18. The audio/video device of claim 9, wherein the communication interface is configured to receive the first caption data and the second caption data from a terrestrial source.

19. The audio/video device of claim 9, wherein the communication interface is configured to receive the first caption data and the second caption data from a digital data storage medium.

20. The audio/video device of claim 9, wherein the communication interface is configured to receive the first caption data and the second caption data from a communication network.
